(19) United States
(12) Patent Application Publication
(10) Pub. No.: US 2002/0046480 A1
(43) Pub. Date: Apr. 25, 2002

(54) Camouflage blind system and method of use

(76) Inventor: James Kowalski, Glen Lyon, PA (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 09/826,066

(22) Filed: Apr. 4, 2001

Related U.S. Application Data
(60) Provisional application No. 60/196,371, filed on Apr. 12, 2000.

(51) Int. Cl. A01M 31/00

(52) U.S. Cl. 43/1; 135/98

(57) ABSTRACT

An improved portable blind for hunting, wildlife watching or the like includes an umbrella like mechanism that is used to open and close a concealment web, which preferably is fabricated from a camouflage fabric and has a number of leafy flaps defined therein that will rustle in the wind for an enhanced camouflage effect. Templates are provided to enable a user to create additional cut out areas in the web for weapon access and/or observation purposes. The umbrella like mechanism includes a central shaft that includes structure that enables it to be mounted directly to a weapon such as a gun or a bow. In addition, the concealment web includes supplemental mounting structure for mounting a portion of the web to a second portion of the weapon for purposes of solidity and stability. A method of hunting utilizing the blind is also disclosed.

This application claims priority under 35 U.S.C. §119(e) based on provisional patent application 60/196,371, filed Apr. 12, 2000, the entire disclosure of which is hereby incorporated as if set forth fully herein.

### BACKGROUND OF THE INVENTION

1. Field of the Invention

This invention relates generally to the field of recreational hunting. More specifically, this invention relates to an improved hunting blind system and method of use that is portable, lightweight, effective and easy to use.

2. Description of the Related Technology

A blind is an article or apparatus that is used by individuals such as photographers, nature watchers and sportsmen to conceal the presence of the individual from wildlife in an outdoor setting. Many blinds are permanent installations that are incapable of being moved from one location to another. Other, portable blinds have also been developed.

One such portable blind, described in U.S. Pat. No. 5,214,872 to Buyalos, Jr., includes a relatively large umbrella shaped mechanism in which a camouflage fabric having one or more visibility ports is secured in place relative to the ground by being clamped to a spike that is driven into the ground. Additional areas of camouflage fabric are also secured to the umbrella shaped mechanism for additional concealment. This particular blind may also be secured to a more permanent structure, such as a tree stand.

Conventional portable blinds are popular with some sportsmen, but are rejected by others who judge such conventional blinds to be too large, heavy and generally unwieldy, particularly when hunting in areas lacking in convenient road access.

A need exists for an improved portable blind that is more lightweight, effective and easy to use than conventional portable blinds.

### SUMMARY OF THE INVENTION

Accordingly, it is an object of the invention to provide an improved portable blind that is more lightweight, effective and easy to use than conventional portable blinds.

In order to achieve the above and other objects of the invention, a portable blind according to a first aspect of the invention includes a concealment web an umbrella mechanism for opening and closing the concealment web. The umbrella mechanism includes a central shaft, a plurality of articulated extendable support elements and a slide mechanism that is moveable on the central shaft for actuating the articulated extendable support elements. The portable blind further includes mounting structure for mounting the umbrella mechanism to a weapon.

According to a second aspect of the invention, a method of hunting includes steps of securing a portable blind to a weapon, opening the portable blind as an umbrella so as to spread a web portion of the portable blind for concealment purposes, and hunting with the weapon while concealing oneself behind the web portion of the portable blind while the portable blind remains secured to the weapon.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a blind constructed according to a preferred embodiment of the invention, shown attached to a compound bow;

FIG. 2 is a fragmentary cross-sectional view depicting a portion of the blind shown in FIG. 1;

FIG. 3 is a perspective view depicting the blind of FIG. 1 being secured to the compound bow;

FIG. 4 is a perspective view depicting a pair of templates being attached to a web portion of the blind shown in FIG. 1 in order to perform one method according to the invention;

FIG. 5 is a perspective view depicting another step in the method shown in FIG. 4;

FIG. 6 is a perspective view depicting a step of securing the web portion of the blind to a second portion of the bow;

FIG. 7 is a perspective view of the blind of FIG. 1 shown secured to a gun; and

FIG. 8 is a diagrammatical depiction of a mechanism that can be used to securing the blind to objects other than weapons.

### DETAILED DESCRIPTION OF THE PREFERRED EMBODIMENT(S)

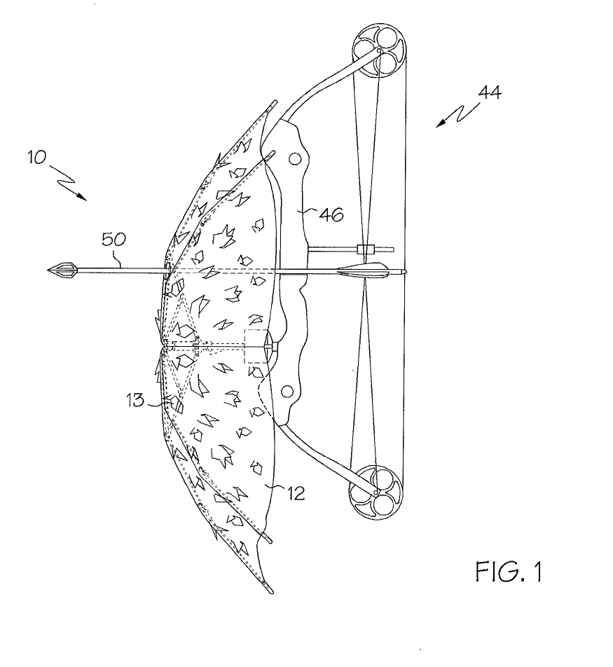

Referring now to the drawings, wherein like reference numerals designate corresponding structure throughout the views, and referring in particular to FIG. 1, a portable blind 10 that is constructed according to the preferred embodiment of the invention includes a concealment web 12, which is preferably fabricated from a camouflage fabric, many of which are commercially available. Preferably, concealment web 12 has a plurality of V-shaped or U-shaped cuts made therein that define leafy projections, and the projections are size and shaped and the fabric is selected so that the leafy projections will tend to rustle in the wind in a natural manner that will enhance the camouflage effect of the blind 10. In the preferred embodiment, each leafy cut out is made so that the projection 13 is about 5 cm in length and about 2 cm in width at its widest point, although this of course could be modified within the scope of the invention.

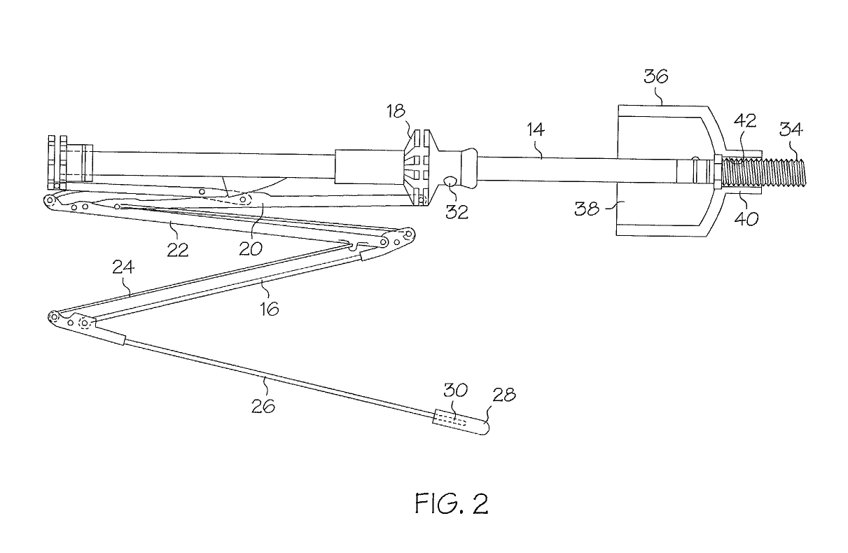

Referring briefly to FIG. 2, portable blind 10 is constructed so that the concealment web 12 is openable and closable by means of an umbrella like mechanism that includes a central shaft 14, a plurality of articulated extendable support elements 16 and a slide mechanism 18 that is moveable on the central shaft 14 for actuating the articulated extendable support elements 16 in order to open and close the umbrella like mechanism. A releasable locking mechanism 32, also similar to those found on conventional umbrellas, is also provided on the slide mechanism 18 and the central shaft 14. In the embodiment that is shown in FIG. 2, the umbrella like mechanism is constructed similarly to a compact personal umbrella for maximum portability and compactability. As may be seen in FIG. 2, the extendable articulated support elements 16 include a first arm 20 that is hingedly mounted to the slide mechanism 18 at a first end and to a second arm 22 at a second end. A second end of the second arm 22 is likewise hingedly mounted to one end of a third arm 24, the second end of which is likewise hingedly mounted to a fourth, outermost arm 26. The fourth, outermost arm 26 is preferably fabricated from a flexible fiberglass material so that it will be able to bend significantly without breaking in the likely event of forceful contact between the portable blind 10 and the environment. According to one important aspect of the invention, a protective element 28 is provided on the outermost end of the outermost arm 26 in order to protect the outermost end from damage that might otherwise be caused by rough contact with the ground, tree limbs, branches or other objects. In the preferred embodiment, protective element 28 is a substantially cylindrical peg like sheath 30 that is mounted over the outermost end of the fourth arm 26 and is larger and sturdier than the corresponding articulated arm end of a conventional umbrella. Preferably, the peg like elements 30 are fabricated from a hard plastic material such as nylon and are at least about 0.25 cm in diameter and at least about 0.5 cm in length. Most preferably, the peg like elements 30 are at least 0.5 cm in diameter and at least 1 cm in length.

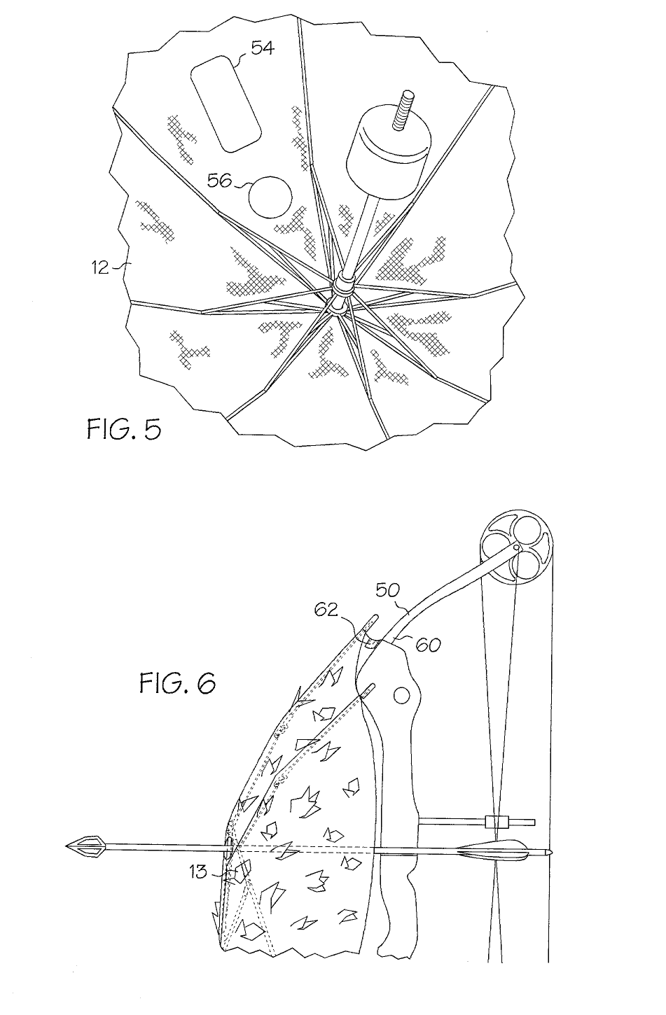

Referring briefly to FIGS. 4 and 5, first and second templates 50, 52 are preferably provided for enabling a user or hunter to customize the portable blind 10 to his or her particular size, stance and weapon. In the preferred embodiment, first template 50 is substantially rectangular in shape and is sized so as to help the user measure and cut a viewing window or observation hole 54 into the concealment web 12. Similarly, the second template 52, which is preferably substantially circular, is provided to help the user measure and cut a hole 56 for a weapon, such as an arrow 50. In the preferred embodiment, the first template 50 guides the user to create an observation opening 54 that is about 9 cm in height and 4.5 cm in width, while the second template 52 guides a user to create a weapon opening 56 that is about 5 cm in diameter. It will be appreciated, however, that the invention encompasses openings and templates of any sizes that are appropriate for the intended use described above.

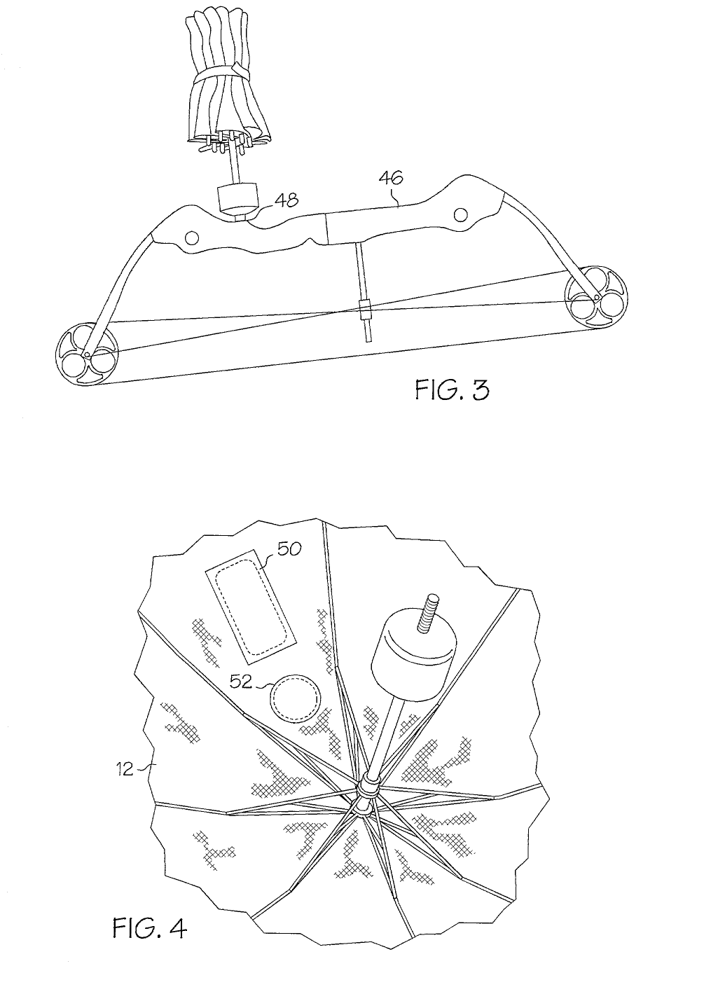

As may be seen in FIG. 1, portable blind 10 further includes mounting structure for mounting the umbrella mechanism to a weapon such as a bow 46. In the preferred embodiment, the mounting mechanism is constructed and arranged to mountain the central shaft 14 of the umbrella mechanism to a weapon 44. As is best shown in FIG. 2, the distal end 34 of the central shaft 14 is threaded, and a cuplike element 36 having a concave open end 38 facing the concealment web 12 is further provided and includes a boss portion 40 having an internal bore 42 that is also threaded so as to mate with the threaded distal end 34 of the central shaft 14. When the umbrella like mechanism is closed and the portable blind 10 is not in use, the concealment web 12 is folded like the fabric of an umbrella and is radially compressed with a strap provided with a hook and loop fastener such as that which is marketed under the trademark Velcro, in a manner that is very similar to a conventional compact umbrella. In this storage position the cuplike element 36 can be rotated so as to travel axially along the central shaft 14 toward the slide mechanism 18, so that the peg like elements 30 will be secured within the concave open end 38 of the cuplike element 36, providing protection to the portable blind 10. In addition, however, the cuplike element 36 and the threaded distal end 34 of the central shaft 14 further function as the mounting mechanism for mounting the umbrella mechanism to an object such as a weapon. As may be seen in FIG. 3, the threaded distal end 34 of shaft 14 may be threaded into a socket that is provided on a stabilizer or riser portion 48 of a bow 46. Stabilizers are manufactured by many companies specifically to enhance the bow's performance. Stabilizers may be made from many different materials, including rubbers, plastics and metals. A stabilizer is generally configured to be screwed into the front of the riser.

Alternatively, if the weapon is provided with a threaded nipple mount instead of a threaded socket the cuplike element 36 could be rotated so that it travels axially toward the distal end 34 of the central shaft 14 and so that a portion of its interior threading becomes available to be screwed on to the threaded nipple mount of the weapon. Accordingly, the assembly that the end of the central shaft 14 including the cuplike element 36 and the threaded distal end portion 34 constitutes the primary mounting mechanism for securing portable blind 10 to the bow 46. Advantageously, the preferred embodiment of the invention further provides a secondary mounting mechanism for securing another portion of the blind 10 to a second portion of the bow for purposes of solidity and stability. As is best shown in FIG. 6, the portable blind 10 is provided with one piece of hook and loop fastener 62 that is sewn into an area of the concealment web 12 that is intended to be positioned at an outermost 12 o'clock orientation when the portable blind 10 is secured to a bow 46. In addition, a second piece of hook and loop fastener 60 is provided with an adhesive backing so as to be securable to an upper portion 58 of the bow 46. In operation, a hunter will first secure the central shaft 14 of the portable blind 10 to the riser or stabilizer of the bow 46, and then will secure the adhesive piece of hook and loop fastener 60 to the upper portion 58 of the bow 46. The hunter will then pull the area of the concealment web 12 having the hook and loop fastener 62 toward the upper portion of the bow 58 and will press the pieces of fastener 60, 62 together in order to releasably secure the concealment web 12 to the upper portion 58 of the bow 46.

When mounted to the riser portion of a bow, portable blind 10 also functions as a stabilizer, both in the closed and open positions. It acts as a stabilizer when folded on the front of the bow by absorbing vibration, and adding balance to the bow, in its compact state. It is even more effective as a stabilizer when the blind 10 is opened on the bow. When the bow is fired, the vibration created by the bow travels through the handle of the bow and into the handle of the portable blind 10, which travels through the mechanism of the blind and greatly reduces noise and vibration. This is aided by the presence of the concealment web 12 and its leafy projections, which might at worst rustle when the bow is fired. In addition, the concave design of the portable blind 10 acts to keep any string noise from reaching the target area. Acting like a parabolic shield on the bow, any remaining string noise is absorbed by the concealment web 12 or reflected back toward the shooter.

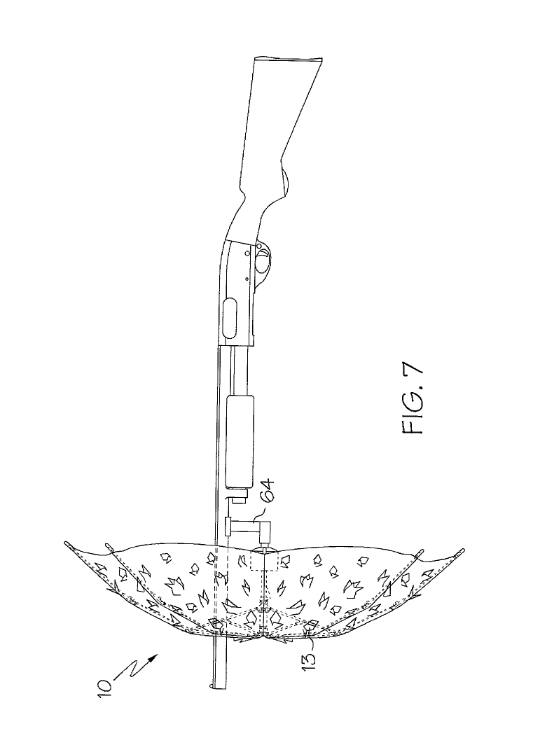

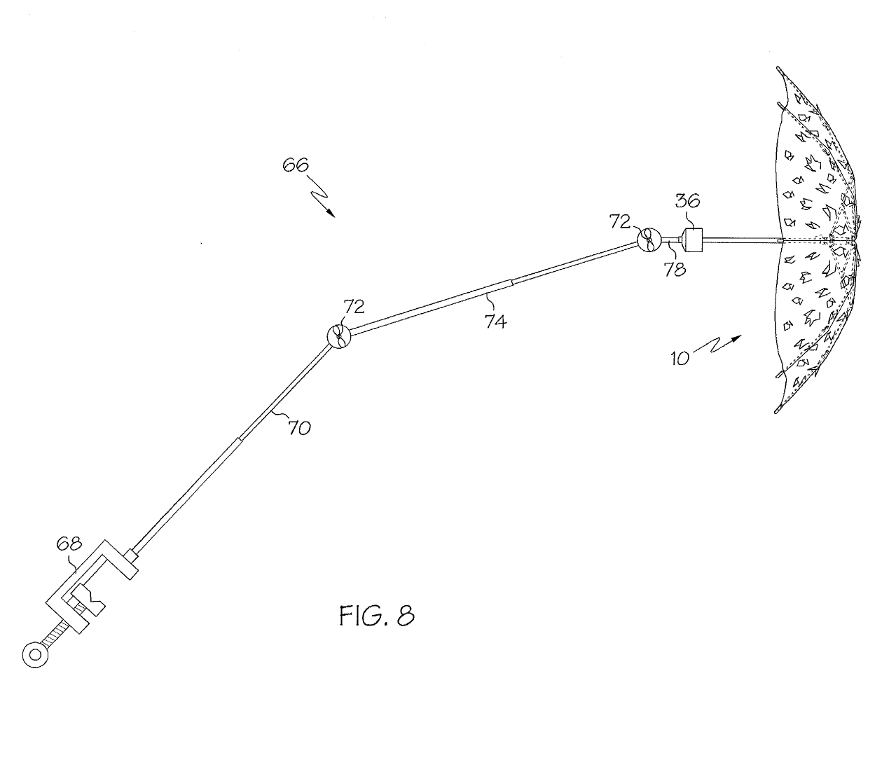

The portable blind 10 could alternatively be used in conjunction with other weapons, or it could be secured to more permanent structures such as stands or permanent blinds. FIG. 7 depicts the portable blind 10 shown secured to a gun that has a bracket 64 which is constructed and arranged to be threaded into the internal bore of the cuplike element 36. FIG. 8 depicts a mechanism 66 that may be used to secure the portable blind 10 to practically any other structure. Mechanism 66 includes a clamp 68 that is secured to an arm 70 which in turn is hingedly mounted to a second arm 74 by means of a swivel clamp hinge 72. A second, opposite end of arm 74 is likewise hingedly mounted to a mounting nipple 78 by means of a swivel clamp hinge 76. Mounting nipple 78 is threaded into the internal bore of the cuplike element 36, in a manner that is described above with reference to the mounting structure of the bow 46.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A portable blind, comprising:
a concealment web;
an umbrella mechanism for opening and closing said concealment web, said umbrella mechanism comprising a central shaft, a plurality of articulated extendable support elements and a slide mechanism moveable on said central shaft for actuating said articulated extendable support elements; and
mounting means for mounting said umbrella mechanism to a weapon.

2. A portable blind according to claim 1,wherein said concealment web comprises a camouflage fabric having a plurality of leafy cuts made therein, each of which defines a flap that may move in wind for an enhanced camouflage effect.

3. A portable blind according to claim 1,wherein said mounting means is constructed and arranged to mount said central shaft of said umbrella mechanism to a weapon.

4. A portable blind according to claim 1, wherein said mounting means is constructed and arranged to mount said umbrella mechanism to a bow.

5. A portable blind according to claim 4, wherein said mounting means is constructed and arranged to secure said central shaft of said umbrella mechanism to a portion of a bow that is selected from the group consisting essentially of bow risers or stabilizers.

6. A portable blind according to claim 4,wherein said mounting means comprises a primary mounting mechanism for securing said central shaft of said umbrella mechanism to one portion of a bow and a secondary mounting mechanism for securing another portion of said blind to a second portion of the bow.

7. A portable blind according to claim 6,wherein said secondary mounting mechanism is for securing a portion of said web to a second portion of the bow.

8. A portable blind according to claim 7,wherein said secondary mounting mechanism comprises a hook and loop fastener.

9. A portable blind according to claim 7,wherein said secondary mounting mechanism is for securing an upper portion of said web to an upper portion of the bow.

10. A portable blind according to claim 1, wherein said mounting means is constructed and arranged to mount said umbrella mechanism to a gun.

11. A portable blind according to claim 1,wherein said central shaft of said umbrella mechanism includes a threaded end portion, and further comprising a cuplike element having a concave, open end and a threaded inner bore, said cuplike element being screwed onto said threaded end portion with said concave open end facing said web.

12. A portable blind according to claim 1, further comprising protective elements positioned on distal ends of at least a plurality of said articulated extendable support elements.

13. A portable blind according to claim 12, wherein said protective elements each comprise a peg like element that is larger and sturdier than the corresponding articulated arm end of a conventional umbrella.

14. A portable blind according to claim 13, wherein said peg like elements are substantially cylindrical and are at least 0.25 cm in diameter and are at least 0.5 cm in length.

15. A portable blind according to claim 1, wherein said umbrella mechanism comprises a plurality of outer arms, and wherein each of said outer arms are fabricated from a flexible break resistant material.

16. A portable blind according to claim 15, wherein said flexible break resistant material comprises fiberglass.

17. A method of hunting, comprising steps of:
(a) securing a portable blind to a weapon;
(b) opening the portable blind as an umbrella so as to spread a web portion of the portable blind for concealment purposes; and
(c) hunting with the weapon while concealing oneself behind the web portion of the portable blind while the portable blind remains secured to the weapon.

18. A method of hunting according to claim 17, wherein step (a) comprises a first step of securing a central shaft portion of the portable blind to a first portion of the weapon and a second step of securing a portion of the web portion of the portable blind to a second portion of the weapon.

19. A method of hunting according to claim 18, wherein said first portion of the weapon is a portion that is selected from the group consisting of a riser and a stabilizer.

20. A method of hunting according to claim 18, wherein said weapon is a bow and said second step comprises securing an upper area of the web portion to an upper portion of said bow.
